(19) United States
(12) Patent Application Publication
(10) Pub. No.: US 2009/0296299 A1
(43) Pub. Date: Dec. 3, 2009

(54) OVERCURRENT CONTROLLER FOR A REMOTELY CONTROLLED CEILING FAN PROVIDED WITH LAMPS AND LANTERNS

(76) Inventor: Hsien-Meng LI, Taichung (TW)

Correspondence Address: SINORICA, LLC, 2275 Research Blvd., Suite 500, ROCKVILLE, MD, 20850, US

(21) Appl. No.: 12/131,165

(22) Filed: Jun. 2, 2008

(51) Int. Cl. H02H 9/02

(52) U.S. Cl. 361/93.2

(57) ABSTRACT

An overcurrent controller for a remotely controlled ceiling fan provided with lamps and lantern, one terminal of which is connected to AC power and the other terminal is connected to at least one ceiling fan and at least one lamp and lantern, the controller comprising a power conversion unit, a microprocessor unit, an overcurrent control unit, a wireless signal control unit, a ceiling fan control unit, and a lamp and lantern control unit. Thus, when the current of lamp and lantern exceeds a set current, the output transition of an operation amplifier of the overcurrent control unit may be achieved to trigger the microprocessor unit, the microprocessor unit being thereby provided with an output in 3 modes: 1. Down-regulation mode; 2. Flicker alarm mode; and 3. Power failure mode for achievement of power saving and prevention of energy waste.

### BACKGROUND OF THE INVENTION

1. Field of the Invention

This invention relates to an overcurrent controller for a remotely controlled fan provided with lamps and lanterns.

2. Description of Related Art

One terminal of a conventional controller for a remotely controlled ceiling fan provided with lamps and lanterns is connected to AC power and the other terminal is connected to a ceiling fan and lamps and lanterns, in which the controller comprises a power conversion unit, a microprocessor unit, a wireless signal control unit, a ceiling fan control unit, and a lamp and lantern control unit, in which the power conversion unit converts the AC power into a DC power and then supplies the DC power to a circuit. The microprocessor unit is connected to the power conversion unit and receives and transmits a triggering signal to control the ceiling fan control unit and the lamp and lantern control unit that are connected to the other terminal. The wireless signal control unit receives a wireless signal and generates a control signal and then transmits the control signal to the connected microprocessor unit and; after the signal is processed by the microprocessor unit, the connected ceiling fan control unit and lamp and lantern control unit are used to control the ceiling fan provided with lamps and lanterns working for clockwise and counterclockwise turn, velocity modulation, and light adjustment. The controller for the remotely controlled ceiling fan provided with lamps and lanterns may drive the ceiling fan with lamps and lanterns to work only for clockwise and counterclockwise turn, velocity modulation, and light adjustment but cannot bring any manner or measure in economy energy; thus, when the power of lamps and lanterns is large consumed, no detection is given soon for a further action to the lamps ad lanterns.

Consequently, because of the technical defects of described above, the applicant keeps on carving unflaggingly through wholehearted experience and research to develop the present invention, which can effectively improve the defects described above.

### SUMMARY OF THE INVENTION

This invention relates to an overcurrent controller for a remotely controlled ceiling fan provided with lamps and lanterns, one terminal of which is connected to AC power and the other terminal of which is connected to at least one ceiling fan and one lamp and lantern, the controller comprising a power conversion unit converting the AC power into output DC power, a microprocessor unit connected to the power conversion unit and receiving and generating a triggering signal, an overcurrent controller triggering the microprocessor unit to control the lamp and lantern by detecting a setting overcurrent of the lamp and lantern, a ceiling fan control unit and a lamp control unit respectively receiving the triggering signals transmitted by the microprocessor unit to control the ceiling fan and the lamp and lantern, and a wireless signal control unit receiving a wireless signal and generating a signal to trigger the microprocessor unit. Through the overcurrent control unit detecting the set overcurrent of lamp and lantern, the lamp and lantern is controlled and adjusted to solve the problem on high power consumption or current generation. Thus, the overcurrent controller for the remotely controlled ceiling fan provided with lamps and lanterns, when the lamps and lanterns generate the set overcurrent, may drive the microprocessor unit to provide a three-mode output for achievement of power saving and prevention of energy waste.

### BRIEF DESCRIPTION OF THE DRAWINGS

FIG. 1 is a circuit block diagram of this invention;

FIG. 2 is a circuit diagram of this invention;

FIG. 3 is a circuit diagram of an overcurrent control unit according to this invention; and

FIG. 4 is a flow chart indicating that a lamp and lantern according to this invention generates a set overcurrent.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

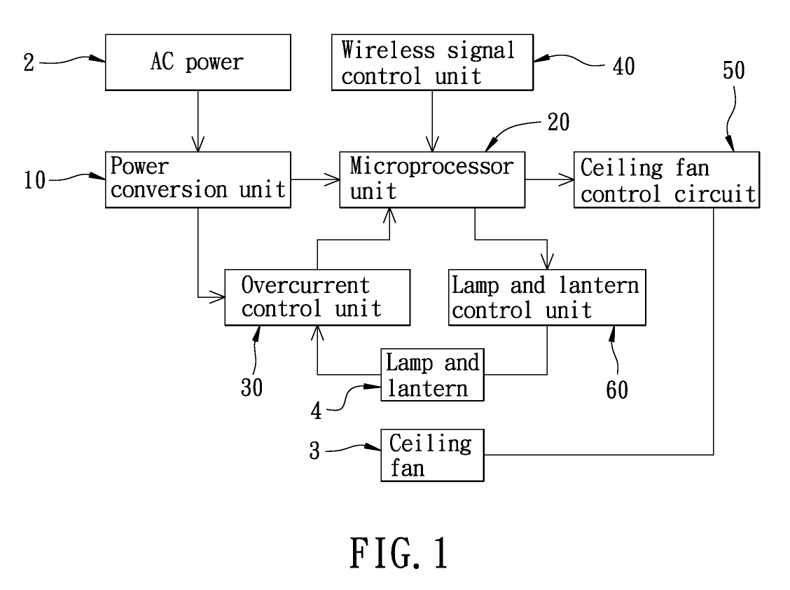

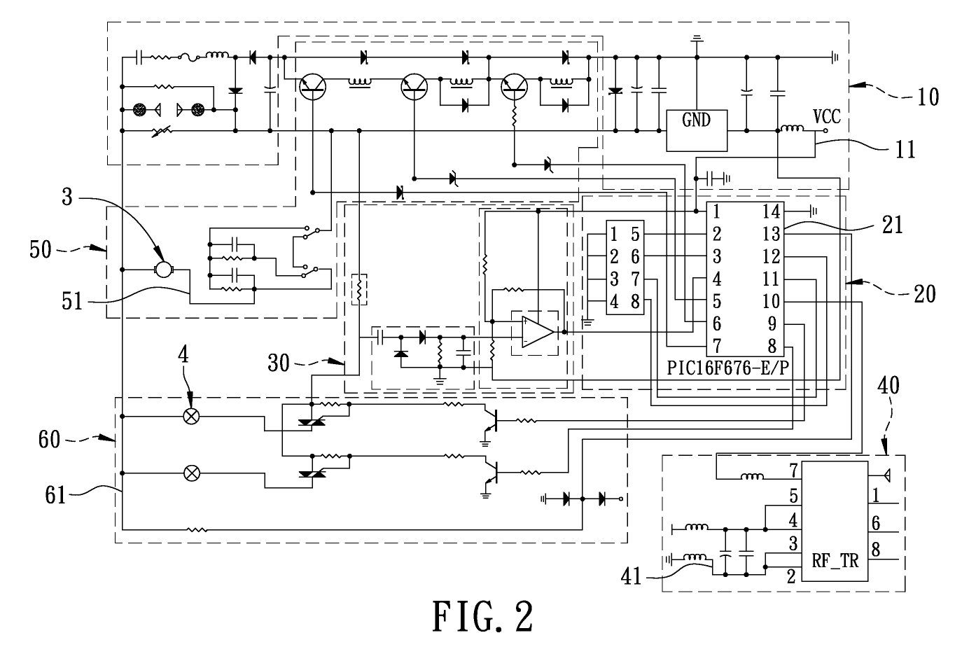

With reference to FIGS. 1 and 2 shown respectively as a circuit block diagram and a circuit diagram of this invention, this invention relates to an overcurrent controller for a remotely controlled ceiling fan provided with lamps and lanterns, one terminal of which is connected to AC power 2 and the other terminal of which is connected to at least one ceiling fan 3 and one lamp and lantern 4, the controller comprising a power conversion unit 10 converting the AC power 2 into output DC power, a microprocessor unit 20 connected to the power conversion unit 10 and receiving and generating a triggering signal, an overcurrent control unit 30 triggering the microprocessor unit 20 to control the lamp and lantern 4 by detecting a setting overcurrent of the lamp and lantern 4, a ceiling fan control unit 50 and a lamp and lantern control unit 60 respectively receiving the triggering signals transmitted by the microprocessor unit 20 to control the ceiling fan 3 and the lamp and lantern 4, and a wireless signal control unit 40 receiving a wireless signal and generating a signal to trigger the microprocessor unit 20. The power conversion unit 10, the microprocessor unit 20, the wireless signal control unit 40, the ceiling fan control unit 50, and the lamp and lantern control unit 60 operate as those provided in a conventional technology and thus are not described in detail, and they are emphasized below as points.

The power conversion unit 10, one terminal of which is connected to the AC power 2, comprises a DC conversion circuit 11 that converts the AC power 2 into the DC power and then supplies it to the microprocessor unit 20 and the overcurrent control unit 30.

The microprocessor unit 20 is connected to the power conversion unit 10 and receives and generates the triggering signal to control the ceiling fan control unit 50 and the lamp and lantern control unit 60, and comprises a microprocessor chipset 21. When the lamp and lantern 4 generates the set overcurrent, the microprocessor unit 20 is provided with an output in 3 modes: 1. Down-regulation mode in which when the current generated by up regulation of the brightness of the lamp and lantern 4 exceeds a set current, the microprocessor unit 20 prohibits the brightness of lamp and lantern 4 from being tuned up and thus allows it only to be tuned down; 2. Flicker alarm mode in which when the current exceeds the set current, the microprocessor unit 20 drives the lamp and lantern 4 to flicker, indicating an alarm status; 3. Power failure mode in which when the current exceeds the set current, after the lamp and lantern 4 flickers a moment, the power is cut.

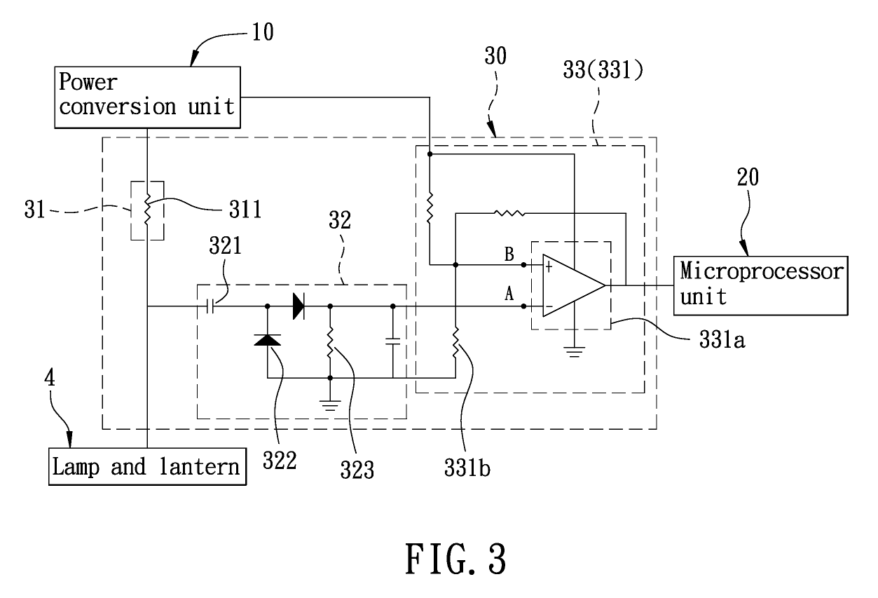

With reference to FIG. 3 as a circuit diagram of the overcurrent control unit according to this invention, one terminal of the overcurrent control unit 30 is connected to the power conversion unit 10 and triggers the microprocessor unit 20 by detecting the set overcurrent of the lamp and lantern 4. In a preferred embodiment of this invention, the overcurrent control unit 30 detects the set overcurrent of the lamp and lantern 4 and may further detect the current of ceiling fan 3 at the same time. The overcurrent control unit 30 comprises a current detection circuit 31, a voltage-doubling rectification circuit 32, and a transition circuit 33. The current detection circuit 31 comprises a detection resistor 311. The voltage-doubling rectification circuit 32 comprises at least one capacitor 321, a rectification diode 322, and a resistor 323. The transition circuit 33 comprises a Schmidt circuit 331, in which the Schmidt circuit 331 comprises an operation amplifier 331a and at least one resistor 331b. One terminal of the detection resistor 311 is connected to the power conversion unit 10, while the other terminal is connected to the lamp and lantern 4 and the circuit 321 in the voltage-doubling rectification circuit 32. The capacitor 321 is connected to the rectification diode 322 that is connected in parallel to a resistor, and the parallel resistor 323 is further connected to a negative input terminal A of the operation amplifier 331a. A positive input terminal B of the operation amplifier 331a is connected to the resistor 331b that is further connected to the power conversion unit 10, and a circuit the current of which is set to 1.5 A uses the current detection circuit 31 to detect the current generated by the lamp and lantern 4. The current is amplified by the voltage-doubling rectification circuit 32 into a high voltage, and the high voltage is meanwhile inputted to the negative input terminal A of the operation amplifier 331a and then compared with a voltage at the positive input terminal B of the operation amplifier 331a; when the voltage at the negative input terminal is higher than that at the positive input terminal B, namely the current generated by the lamp and lantern 4 being the set overcurrent, the operation amplifier 331a generates a signal and triggers the microprocessor unit 20.

The wireless signal control unit 40, when receiving a wireless signal, generates a triggering signal, the unit 40 comprising a wireless signal receiving circuit 41 that may receive a wireless signal transmitted by a remote controller to trigger the microprocessor unit 20 and then drive the microprocessor unit 20 to control the ceiling fan control unit 50 and the lamp control unit 60.

One terminal of the ceiling fan control unit 50 is connected to the microprocessor unit 20, and the other terminal is connected to the ceiling fan 3, in which the unit 50 comprises a ceiling fan control circuit 51 that controls the ceiling fan 3 for counter/clockwise turn and velocity modulation when receiving the triggering signal transmitted by the microprocessor unit 20.

One terminal of the lamp and lantern control unit 60 is connected to the microprocessor unit 20, and the other terminal is connected to the lamp and lantern 4, in which the unit 60 comprises a lamp and lantern control circuit 61 that controls the lamp and lantern 4 for light adjustment when receiving the triggering signal transmitted by the microprocessor unit 20.

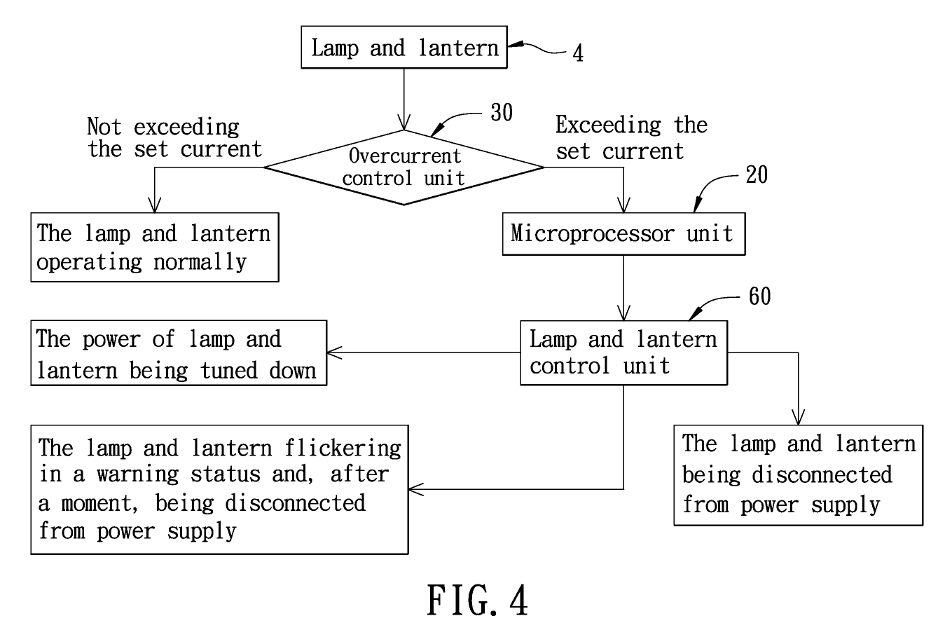

With reference to FIG. 4 as a flow chart indicating that the lamp and lantern 4 according to this invention generates the set overcurrent, the current detection circuit 31 of overcurrent control unit 30 according to this invention detects the current generated by the lamp and lantern 4. The current is amplified by the voltage-doubling rectification circuit 32 into a high voltage, and the high voltage is meanwhile inputted to the negative input terminal A of the operation amplifier 331a and then compared with a voltage at the positive input terminal B of the operation amplifier 331a; when the voltage at the negative input terminal is higher than that at the positive input terminal B, namely the current generated by the lamp and lantern 4 being the set overcurrent. Then, the operation amplifier 331a generates a signal and triggers the microprocessor unit 20 to make the microprocessor unit 20 to be provided with an output in 3 modes: 1. Down-regulation mode in which when the current generated by up regulation of the brightness of the lamp and lantern 4 exceeds a set current, the microprocessor unit 20 prohibits the brightness of lamp and lantern 4 from being tuned up and thus allows it only to be tuned down; 2, Flicker alarm mode in which when the current exceeds the set current, the microprocessor unit 20 drives the lamp and lantern 4 to flicker, indicating an alarm status; 3. Power failure mode in which when the current exceeds the set current, after the lamp and lantern 4 flickers a moment, the power is cut, in which the microprocessor unit 20 may be used to lower the power consumed by the lamp and lantern 4 and further lower the current generated by the lamp and lantern 4, and contrarily the lamp and lantern 4 keeps working normally if the current generated by the lamp and lantern 4 does not exceed the set current.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An overcurrent controller for a remotely controlled ceiling fan provided with lamps and lantern, one terminal of which is connected to AC power and the other terminal is connected to at least one ceiling fan and at least one lamp and lantern, the controller comprising a power conversion unit, a microprocessor unit, an overcurrent control unit, a wireless signal control unit, a ceiling fan control unit, and a lamp and lantern control unit, in which the AC power is connected to the power conversion unit and supplied to the microprocessor unit and the microprocessor unit, when receiving control signals transmitted by the overcurrent control unit and the wireless signal control unit, controls the ceiling fan control unit and the lamp and lantern control unit and further controls the ceiling fan and the lamp and lantern, being characterized in that:
the power conversion unit, one terminal of which is connected to the AC power, comprises a DC conversion circuit and generates DC power supplied to the microprocessor unit and the overcurrent control unit;
the microprocessor unit is connected to the power conversion unit and receives and generates a triggering signal to control the ceiling fan control unit and the lamp and lantern control unit;
one terminal of the overcurrent control unit is connected to the power conversion unit and, by detecting the set overcurrent of the lamp and lantern, triggers the microprocessor unit, comprising a current detection circuit, a voltage-doubling rectification circuit, and a transition circuit, in which one terminal of the current detection circuit is connected to the lamp and lantern and the other terminal is connected to the voltage-doubling rectification circuit the other terminal of which is connected to the transition circuit the other terminal of which is connected to the microprocessor unit;
the wireless signal control unit, when receiving a wireless signal, generates a triggering signal to control the microprocessor unit, the unit comprising a wireless receiving circuit that, when receiving a wireless signal, controls the microprocessor unit;
one terminal of the ceiling fan control unit is connected to the microprocessor unit, and the other terminal is connected to the ceiling fan, in which the unit comprises a ceiling fan control circuit that, when receiving the triggering signal transmitted by the microprocessor unit, controls the ceiling fan; and
one terminal of the lamp and lantern control unit is connected to the microprocessor unit, and the other terminal is connected to the lamp and lantern, in which the unit comprises a lamp and lantern control circuit that, when receiving the triggering signal transmitted by the microprocessor unit, controls the lamp and lantern.

2. The overcurrent controller for the remotely controlled ceiling fan provided with lamps and lantern according to claim 1, wherein the transition circuit is a Schmidt circuit.

3. The overcurrent controller for the remotely controlled ceiling fan provided with lamps and lantern according to claim 1, wherein the current detection circuit of overcurrent control unit is used to detect the current generated by the lamp and lantern as a load.

4. The overcurrent controller for the remotely controlled ceiling fan provided with lamps and lantern according to claim 1, wherein the overcurrent control unit may further detect the current of the lamp and lantern and ceiling fan at the same time.
